(19) United States
(12) Patent Application Publication
(10) Pub. No.: US 2006/0286536 A1
(43) Pub. Date: Dec. 21, 2006

(54) System and method for regulating use of content and content styles in a distributed learning system

(76) Inventors: Sherman Mohler, Gilbert, AZ (US); Rodney James Hing, Phoenix, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/394,628

(22) Filed: Mar. 31, 2006

Related U.S. Application Data
(60) Provisional application No. 60/667,583, filed on Apr. 1, 2005.

(51) Int. Cl. G06F 15/16; G09B 3/00

(52) U.S. Cl. 434/350; 709/201

(57) ABSTRACT

Systems and methods for providing content and enabling users to add or modify content and content styles associated with a distributed learning system are provided. A server stores content objects developed by one or more authors, and a permissions module regulates access to the content objects based upon stored permission settings. The methods comprise receiving a request from a user to add or modify content or a content style, retrieving permissions information associated with the request, and providing or not providing access to the requested content or content style, based upon the retrieved permissions information. In some embodiments, methods are provided by which content objects can be dynamically rendered by various organizations to generate courses tailored to each organizations themes and visual styles.

### RELATED APPLICATIONS

This application claims priority to U.S. Provisional Patent Application No. 60/667,583, filed Apr. 1, 2005, the disclosure of which is incorporated by reference herein. This application also incorporates by reference the full disclosures of U.S. Patent Publication No. 2002/0138841 to Ward, published on Sep. 26, 2002 and entitled “System For Distributed Learning;” U.S. Provisional Patent Application No. 60/603,004 filed Aug. 20, 2004, entitled “System And Method For Content Packaging In A Distributed Learning System;” and U.S. patent application Ser. No. 11/209,196 to Mohler et al., also entitled “System and Method For Content Packaging In A Distributed Learning System.”

### BACKGROUND OF THE INVENTION

1. Field of the Invention

The present invention relates generally to educational programs and specifically to systems and methods facilitating collaborative authorship of online learning content.

2. Description of the Related Art

With the evolution of the Internet, teaching students through online teaching systems has become more popular. These online teaching systems provide electronic versions of curriculums, and tests to assess how well the students have mastered the information. These systems thereby provide the teacher with additional tools for teaching students a particular subject matter.

### SUMMARY OF THE INVENTION

In one aspect, a system for managing content for a distributed learning system over an electronic network is provided, comprising one or more servers and a permissions module. The one or more servers store a plurality of educational courses configured to be delivered electronically to students over the network. At least some of the courses comprise one or more content objects also stored on the one or more servers. At least some of the content objects are reusable content objects configured to be used in more than one of the courses. The permissions module is configured to regulate whether users can use the reusable content objects in the courses, based upon permission settings stored in association with the reusable content objects.

In another aspect, a method is provided for regulating access to educational content objects over an electronic network, for a distributed learning system. The method includes storing a plurality of educational courses configured to be delivered electronically to students over the network. At least some of the courses comprise one or more content objects. At least some of the content objects are reusable content objects configured to be used in more than one of the courses. The method further includes receiving a user's request to add one of the reusable content objects to one of the courses, retrieving permissions information associated with the requested content object, and providing or not providing access to the requested content object, in accordance with the permissions information.

In another aspect, a method is provided for regulating permission settings of one or more content objects associated with a distributed learning system. The content objects are stored in association with a plurality of educational courses configured to be delivered electronically to students. The permission settings govern users' abilities to add selected ones of the content objects to the courses. The method comprises receiving a request from a user to modify permission settings for an identified one of the content objects, retrieving access information associated with the user, and allowing or not allowing the user to modify the permission settings for the identified content object and any content object below the identified content object in a hierarchical course outline of one of the courses, based on the access information.

In another aspect, a system is provided for controlling content styles for the presentation of educational courses over an electronic network. The system comprises one or more servers and a content style module. The one or more servers are configured to store content styles, each content style configured to be selectively applied to one of more of the courses. Each content style is also configured to control presentational formatting of an associated course delivered to students over the network. The content style module is configured to regulate a user's ability to apply a selected one of the content styles to a selected one of the courses based upon stored access information of the user.

In another aspect, a method is provided for controlling content styles for the presentation of educational courses over an electronic network. The method includes storing content styles configured to be selectively applied to one or more of the courses, each content style configured to control presentational formatting of an associated course delivered to students over the network. A request is received from a user's client computer to apply a selected one of the content styles to a selected one of the courses. Access information associated with the user is retrieved. The user is allowed or not allowed to apply the selected content style to the selected course, based upon the retrieved access information.

In another aspect, a method is provided for controlling content styles for the presentation of educational courses over an electronic network. The method comprises storing content styles configured to be selectively applied to one or more of the courses, each content style configured to control presentational formatting of an associated course delivered to students over the network; organizing the content styles within content theme directories; receiving a user's request to store a new content style within a selected one of the content theme directories; retrieving permissions information associated with the content theme directory; and permitting or not permitting the user to store the new content style within the selected content theme directory, based upon the retrieved permissions information.

In another aspect, a method of sharing content objects between project spaces is provided. In accordance with the method, a first project space associated with a first organization is provided, the first project space including educational course materials configured to be delivered electronically to students over a network. Access to the first project space is provided to a first plurality of authors associated with the first organization. A second project space associated with a second organization is also provided, the second project space including educational course materials configured to be delivered electronically to students over the network. Access to the second project space is provided to a second plurality of authors associated with the second organization. The first plurality of authors is prevented from accessing the second project space, and the second plurality of authors is prevented from accessing the first project space. A joint space accessible by the first and second pluralities of authors is provided. At least some of the first plurality of authors are permitted to transfer content objects from the first project space into the joint space.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 illustrates a block diagram of a distributed learning system, according to aspects of an embodiment of the invention.

FIG. 2 illustrates a block diagram of an authoring and management interface system, according to aspects of an embodiment of the invention.

FIG. 3 illustrates a screen display of a lesson display screen, according to aspects of an embodiment of the invention.

FIG. 4 is a screen capture of a lesson page shown on a normal size computer display.

FIG. 5 is a screen capture of a lesson page shown on a personal digital assistant, containing the same content of FIG. 4, according to aspects of an embodiment of the invention.

FIG. 6 is a screen capture of an authoring system, according to aspects of an embodiment of the invention.

FIG. 7 is a screen capture of an authoring system once a permissions window has been activated, according to aspects of an embodiment of the invention.

FIG. 8 is a flow chart illustrating a process of setting permissions on one or more content objects, according to aspects of an embodiment of the invention.

FIG. 9 is a flow chart illustrating a process by which a user adds or modifies a visual style, according to aspects of an embodiment of the invention.

FIG. 10 is a screen capture of a super administrator home page according to aspects of an embodiment of the invention.

FIG. 11 includes a screen capture of an organization administrator home page according to aspects of an embodiment of the invention.

FIG. 12 includes a screen capture of a content style permissions page according to aspects of an embodiment of the invention.

FIG. 13 includes a screen capture of a content style list page according to aspects of an embodiment of the invention.

FIG. 14 includes a screen capture of a content style maintenance page for adding a new content style, according to aspects of an embodiment of the invention.

FIG. 15 includes a screen capture of a content style addition page for adding a new content style, according to aspects of an embodiment of the invention.

FIG. 16 includes a screen capture of a content style modification page for modifying a content style, according to aspects of an embodiment of the invention.

FIG. 17 is a schematic illustration of a pristine content object sharing environment, according to aspects of an embodiment of the invention.

FIG. 18 is a schematic illustration of a pristine content object sharing environment comprising a joint project space, according to aspects of an embodiment of the invention.

### DETAILED DESCRIPTION OF CERTAIN INVENTIVE ASPECTS

Certain embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein.

One embodiment of the invention relates to a distributed learning system that allows authors to collaborate as they develop course materials. In one embodiment, the distributed learning system, herein referred to as “the system,” includes a plurality of servers that store course material from multiple authors and a permissions module that regulates access to the course material. A delivery engine is configured to transfer the course material to one or more students.

The system allows authors to create content objects for use in educational courses. The system also preferably allows a first author to use content created by a second author in course materials developed by the first author. The course materials are preferably delivered to students in a seamless manner that does not reveal or suggest the fact that the various portions of the course may have been developed by different authors. An author can preferably regulate use of his or her original content in a variety of ways, including, for example, (1) allowing other authors to view the original content, (2) allowing other authors to insert a read-only copy of the original content into their own course materials (a “reference” to the original content), (3) allowing other authors to insert a hyperlink to the original content into their own course materials (a “link” to the original content), (4) allowing other authors to insert an editable copy of the original content into their own course materials (a “repurpose” of the original content), and (5) allowing other authors to edit the original content itself. It will be understood that any combination of these access levels can be provided, and any one or more of them can be affirmatively denied. Also, access to content can be set (e.g., by the original author) for each individual “content object” (as defined below) or related group of objects. Further, access levels can vary from user to user, with some users (e.g., super administrators or organizational/project administrators) having greater access levels to content than other users.

Another embodiment of the invention relates to a method by which the system permits authors (also referred to herein as “users”) to set permissions on one or more course materials or portions of course materials (collectively referred to as “content objects”). In one embodiment, an author logs into the system and sets edit and sharing permissions for a content object and all subservient content objects in a hierarchy of content objects. In another embodiment, an administrator (“project/organizational administrator” or a system's “super administrator”) logs into the system and sets edit, sharing and lockdown permissions for a content object and all subservient content objects. Under lockdown, authors are not permitted to modify a content object. The lockdown option is preferably only available to higher level administrators.

In a preferred embodiment, the author's role is essentially limited to developing content in accordance with desired instructional and/or learning strategies. The choice of instructional and/or learning strategies may require the author to apply appropriate formatting data (e.g., metadata) to the content objects (e.g., tagging a content object as “instructor's eyes only” or “student warning,” or the like). In the preferred embodiment, a content delivery engine delivers the authored materials to students in a presentation format dictated in-part by the formatting data, and in-part by the selection of a “visual style” and a “theme” (selected by, e.g., an administrator of an organization or university associated with the particular students that receive the course materials). A visual style governs the branding, logos, images, fonts, colors, and the like, associated with delivered course materials. A theme governs presentation structure based on the specific types of content delivered. A “content style” is the resultant effect of combining a specific visual style and a specific theme. Visual styles, themes, and content styles are described further below. The system preferably allows users with appropriate permissions to add or modify visual styles and/or themes.

In a preferred embodiment, users (e.g., authors, administrators) of different organizations have the ability to share content objects across organizational boundaries and to work collaboratively in developing course materials. In one embodiment, content objects developed by a first organization are transferred to a second organization and, upon combination with the second organization's themes and visual styles (i.e., content styles), are used to generate course material tailored to the second organization. In another embodiment, users are permitted to share content objects across project spaces within the same organization only.

Distributed Learning System

Embodiments of the present invention relate to a distributed learning system. The learning system allows for the dynamic creation of teaching materials personally tailored for the needs of the individual striving to learn the course material.

The preferred system allows for courses to be designed by content authors and then presented to students over a network, such as the Internet. Each course is composed from a set of learning objectives aimed at teaching the student a certain desired set of skills. One learning objective (LO), for example, might be to learn how to program a computer. This is an example of a very broad learning objective. Accordingly, each learning objective may include a defined set of target indicators (TI's). For example, the LO could be Visual Basic knowledge and the TI's might include command instructions in Visual Basic or display techniques of Visual Basic. Accordingly, each TI could include an indicator that the student has learned the learning objective. The overall course could be called “How to Program a Computer”.

In order to teach a student a TI, a series of content items (CI's) and content sections (CS's) can be provided. Each content item includes information that relates to its TI. For example, if the TI is Visual Basic knowledge, related content items might include text pages showing Visual Basic commands. Each page displays one or more content items. Preferably, content items can include child content items and content sections, and a content item or content section can serve a parent content item or content section. Alternatively, a set of related commands might also be a single content item. In addition, content items can be, e.g., image files, video files, text files or sound files that provide information for the particular target indicator. A content item can itself include one or more other content items and content sections.

Associated with the content items are one or more assessment items (AI's), which are typically examination questions that test the student's knowledge of the content item. For example, if the content item includes text that teaches how to use the command “PRINT” from Visual Basic, the assessment item might include a question such as “What command is used to print to the printer?” This allows assessment of the student's knowledge of the content item (or plurality of content items). Such a test would not necessarily have to be in written form, but could also be performed through image, video and/or sound files. Because of the relationship between content items and assessment items, the system can provide a very granular analysis of what a particular student has learned. By providing a set of assessment items that test for knowledge of particular content items, instructions within the system can determine which content items have been learned by the student, and which content items are not known. Additionally, AI's can be reused across multiple LO's and TI's. For example, an AI associated with an LO can be used with another LO. Further, a user (e.g., author, administrator, or super administrator) can declare relationships among AI's and any number of LO's, TI's, CO's and CS's.

There are typically two modes of AI usage, both of which include giving a student one or more questions to gauge the student's level of understanding of the course material. In one mode, herein referred to as “formative capacity,” a score relating to the student's performance is not calculated. In another mode, herein referred to as “summative capacity,” a score is calculated.

Once a determination is made of the content items that need to be learned, the system can provide varying types of content items (or personalized feedback) to teach the student. For example, if the student cannot answer the question “What command is used to print to the printer?”, the system can then display additional Visual Basic command text, play a video, or play a sound file that instructs the student on the use of the command “PRINT”.

As discussed below, a student can access the course through a computer system. In one embodiment, the course is presented within a browser software program such as Internet Explorer from Microsoft Corporation, or Netscape Navigator from Netscape Corporation. Once the student has requested the course, the course is presented to the student through the browser software executing on the student's computer system.

Embodiments of the system are configured to monitor and determine the student's learning preference as the student proceeds in the course and interacts with the curriculum. The system also is capable of testing the student to determine which portions of the curriculum the student has understood. Thus, the system is able to determine the student's progress in the course and the student's comprehension of the contents of the course.

If the system determines through testing that a student has not fully comprehended some aspect of the coursework, the system may provide additional information on the unlearned portions of the course. This additional information can be placed within a subsequent supplementary course to be presented to the student, or be part of the same curriculum. Moreover, the system can provide the supplementary information in a format most useful to the student. For example, if the student has been found to learn most effectively through visual teaching, a video on demand (VOD) can be presented to the student. Conversely, if the student has been found to learn most effectively through reading, the system can present the student with written information.

The learning system described herein also can utilize an external cache system for delivering content to the students through its Caching Application Programming Interface (API). In one embodiment, the Caching API interfaces with a controlled replication and content routing system, such as the Self-Organizing Distributed Architecture (SODA) developed by SitePath, Inc. (Waltham, Mass.). Of course, the Caching API is not limited to interface with only a specific type of caching scheme. Other schemes, such as the Digital Island system disclosed in U.S. Pat. No. 6,185,598, issued on Feb. 6, 2001, which is hereby incorporated by reference in its entirety, could also be used.

For example, a course delivery engine that stores the coursework to be presented is maintained centrally. However, copies of the course contents are transmitted and maintained at a location local to the student's computer system. For instance, a copy of the curriculum might be maintained on the student's local area network (LAN). However, because the system described herein is capable of connecting together many sites throughout the world, copies of the curriculum can be stored, for example, within a server in each country and within a server for each region of the world. By keeping copies of the course contents distributed onto multiple servers that are near the student's sites, the system is capable of delivering content to the student more efficiently.

Providing this caching mechanism allows an embodiment of the system to incorporate instructions for tracking when curriculum has been updated on the central server. Once a particular curriculum file is updated, a new copy of the updated curriculum is sent to each of the remotely cached sites so that the students may be provided with the most up-to-date information.

### DEFINITIONS

1. Application Programming Interface (API)

An API is a set of routines, protocols, and tools for building software applications. An API facilitates the development of software programs or systems by providing the building blocks that may be utilized in building a software program or system. A programmer can then access and use the API to create or modify a software program or system.

2. Assessment Items

Assessment items are queries that may be posed to the student to indicate the student's comprehension of the course material. The assessment items can be content-related questions, such as, for example, true or false questions, multiple choice questions, fill-in-the-blank questions, point and click questions, drag-and-drop questions, free text questions, and the like.

3. Content Items

Content items refer to the presentation of educational material, including any tools that can deliver or contain educational content. Content items can be in many forms, such as, for example, image files, video files, sound files, Microsoft Word documents, Microsoft PowerPoint presentations, Flash animations, streaming video, collaborative work environments, or any tool that can deliver educational content. Content items can contain one or more content items (CI's) and content sections (CS's), which are preferably metadata tagged to reflect instructional design (e.g., learning styles or instructional strategies). One example of a section instructional design is a questions and answers (Q&A) format. Another example of a section instructional design is a computer-implemented guide or advisor (e.g., “guru”) to facilitate a student's learning experience. Content items can map to target indicators, which can in turn map to learning objectives.

4. Course

A course is a collection of learning objectives, TIs, CIs and CSs aimed at teaching a certain curriculum to a student. A course can be designed and presented to students over a network, such as the Internet. Each course may be composed of one or more learning objectives. A “course material” broadly refers to a course or a portion of a course.

5. Input Devices

Input devices are capable of transmitting information from a user to a computer, for example, a keyboard, rollerball, mouse, voice recognition system or other device. The input device may also be a touch screen associated with the display, in which case the user responds to prompts on the display by touching the screen. The user may enter textual information through the input device such as the keyboard or the touch-screen.

6. Instructions

Instructions refer to computer-implemented steps for processing information in the system. Instructions can be implemented in software, firmware or hardware and can include any type of programmed step undertaken by components of the system.

7. Local Area Network (LAN)

One example of the Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

8. Learning Objectives

Learning objectives refer to major topics, i.e. educational goals, which are typically not easily assessable. The learning objectives may include broad concepts, such as, for example, “Understanding the Use of a Web Browser”. A learning objective typically is separated into smaller conceptual units (target indicators) which can be more easily taught and tested. A learning objective is generally generated by a job task or skills analysis. One or more learning objectives normally form a complete course.

9. Media

Media refers to images, sounds, video or any other multimedia type data that is entered into the system.

10. Miciroprocessor

The microprocessor may be any conventional general purpose single- or multi-chip microprocessor, such as a Pentium® processor, a Pentium® Pro processor, a 8051 processor, a MIPS® processor, a Power PC® processor, an ALPHA® processor, or other general purpose microprocessor, including those yet to be developed. In addition, the microprocessor may be any conventional special purpose microprocessor, such as a digital signal processor or a graphics processor. The microprocessor typically has conventional address lines, conventional data lines, and one or more conventional control lines.

11. Modules

A system is comprised of various modules as discussed in detail below. As can be appreciated by one of ordinary skill in the art, each of the modules may comprise various sub-routines, procedures, definitional statements and macros. Each of the modules are typically separately compiled and linked into a single executable program. Therefore, a description of each of the modules is used for convenience to describe the functionality of certain embodiments of the system. Thus, the processes that are undergone by each of the modules may be arbitrarily redistributed to one of the other modules, combined together in a single module, or made available in, for example, a shareable dynamic link library.

12. Networks

The system may include any type of electronically connected group of computing systems (“electronic network”), including, for example, one or more of the networks from the following non-exhaustive list: Internet, Intranet, Local Area Networks (LAN) or Wide Area Networks (WAN). In addition, the connectivity to the network may be, for example, by way of remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, wireless, set-top, or any other desired type of configuration. As used herein, an Internet includes network variations such as public Internet, a private Internet, a secure Internet, a private network, a public network, a value-added network, an Intranet, and the like. In other words, as used herein, the term network refers to any type of connectivity between computing devices for the transfer of data.

13. Operating Systems

The system may be used in connection with various operating systems, such as those from the following non-exhaustive list: UNIX, Disk Operating System (DOS), OS/2, Windows 3.X, Windows 95, Windows 98, Windows NT, including other operating systems yet to be developed. New operating systems and revisions of existing operating systems are continually being developed, and these are also within the scope of the present invention.

14. Programming Languages

The system may be written in any programming language such as Java, C, C++, Visual Basic, Pascal, Java, and FORTRAN, and executed under one or more of the many well-known operating systems, such as Microsoft Windows, Linux and UNIX. C, C++, BASIC, Pascal, Java, and FORTRAN are industry standard programming languages for which many commercial compilers can be used to create executable code.

15. Target Indicators

Target indicators are assessable educational sub-topics that are portions of the broader learning objective. Each learning objective may be composed of one or more target indicators.

16. Transmission Control Protocol

Transmission Control Protocol (TCP) is a transport layer protocol used to provide a reliable, connection-oriented, transport layer link among computer systems. The network layer provides services to the transport layer. Using a two-way handshaking scheme, TCP provides the mechanism for establishing, maintaining, and terminating logical connections among computer systems. TCP transport layer uses Internet Protocol (IP) as its network layer protocol. Additionally, TCP provides protocol ports to distinguish multiple programs executing on a single device by including the destination and source port number with each message. TCP performs functions such as transmission of byte streams, data flow definitions, data acknowledgments, lost or corrupt data re-transmissions and multiplexing multiple connections through a single network connection. Finally, TCP is responsible for encapsulating information into a datagram structure.

17. Web Browser

A web browser is a software or hardware device capable of displaying graphical and/or textual information from a web page on a computing device. For example, popular web browsers presently include those commercially available from companies such as Netscape, Microsoft Corporation, Mozilla Corporation and the like.

18. Object

An “object” (or “content object”) refers to a course material, such as an entire course or course portion. An object is preferably part of a hierarchy of objects. An object may be subservient to other objects in a hierarchy (i.e., an object may have a parent object). An object may have objects that serve it in the hierarchy (i.e., an object may have child objects). Additionally, multiple objects may be associated with the same parent object. An object may be an editable copy (“repurpose”), link, or a read-only copy (“reference”) of an object. Objects directly underneath the same parent object are herein referred to as “siblings.” As one example, an object may be a content item. As another example, an object may be a course selected from a plurality of courses within a particular project. In such a case, the course may contain one or more LO's, TI's, CI's and CS's.

Overview

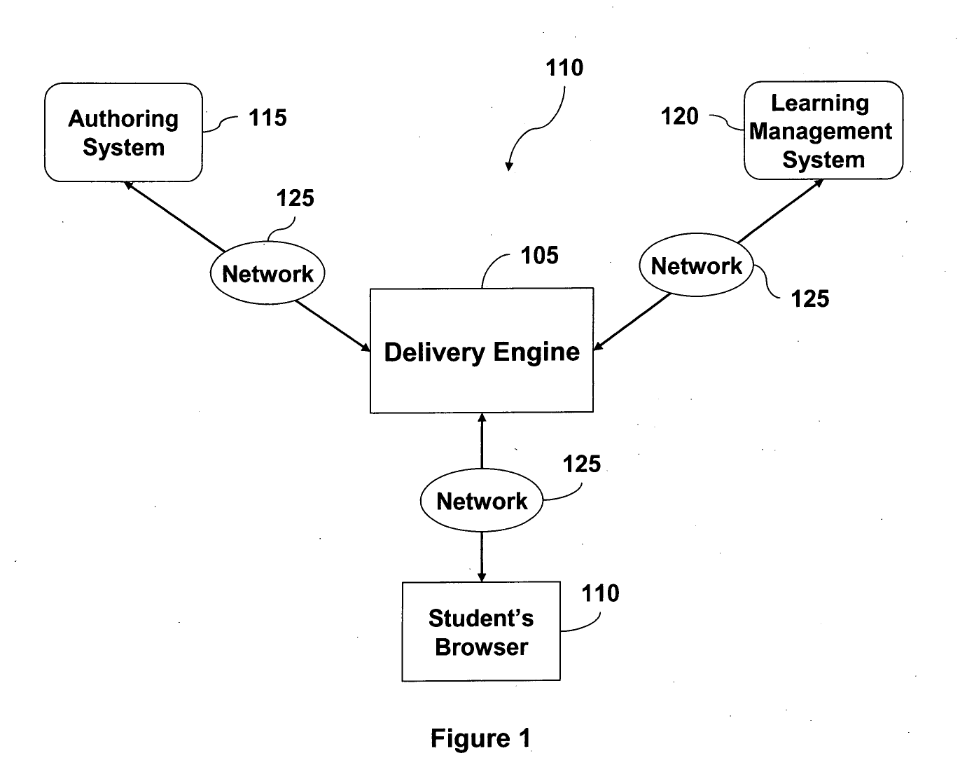

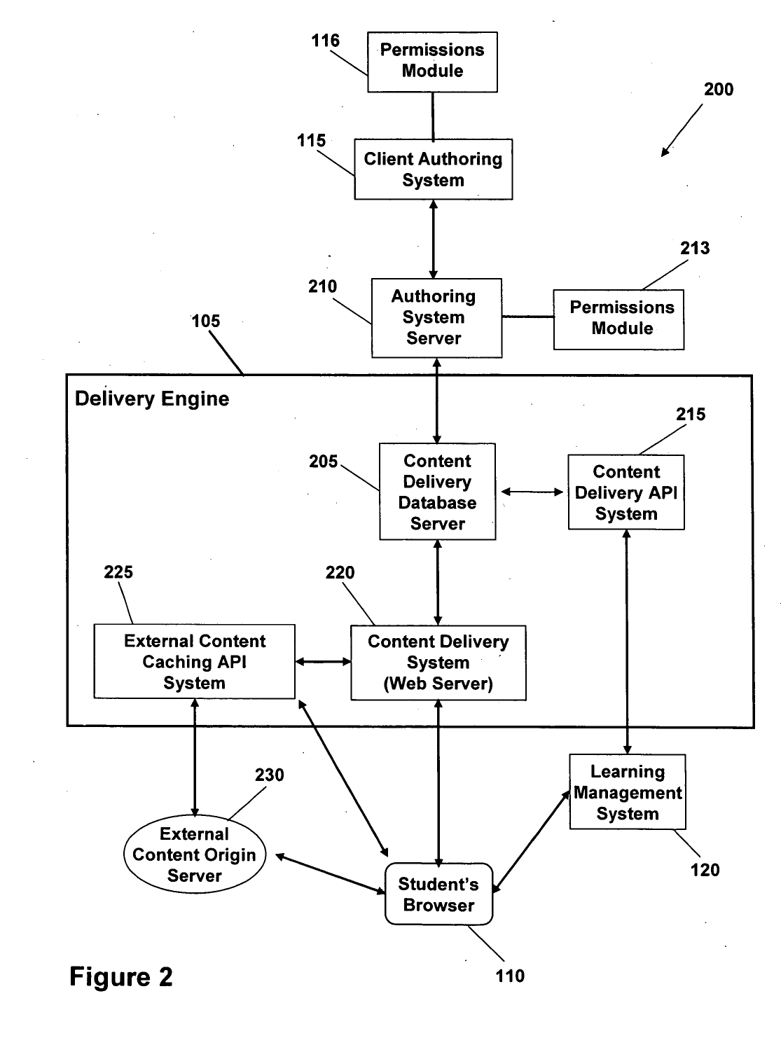

FIG. 1 illustrates a block diagram of one embodiment of a distributed learning system 100. As shown, the distributed learning system 100 includes a delivery engine 105 for delivering content through the system. The delivery engine 105 sends content data to a student's browser 110 via a network 125. In addition, authors can use an authoring system 115 (preferably a dedicated software application running on a client computer system) that is linked via the network 125 to the delivery engine 105 to create content. The authoring system 115 is preferably associated with a permissions module 116 (FIG. 2). Also, a learning management system (“LMS”) 120 communicates with the delivery engine 105 via the network 125 in order to control the flow of content through the system. The LMS is preferably a browser-based system. These modules and systems are explained in more detail with regard to the following figures.

FIG. 2 illustrates a block diagram of one embodiment of the learning system 100. As shown, the authoring and management interface system 200 includes the delivery engine 105, the student's browser 110, the authoring system 115, the learning management system 120, and an external content origin server 230.

In one embodiment, the delivery engine 105 includes a content delivery database server 205 that stores content objects from the authoring system 115. These content objects are developed for eventual delivery to the students as part of a curriculum. As discussed above, these content objects can include content items, such as text, video or sounds that are part of a particular curriculum being taught. The delivery engine 105 also includes a content delivery API system 215, a content delivery system 220 (preferably a web server), and an external content caching API system 225. The delivery engine 105 communicates with an authoring system server 210, which is also preferably a web server. It will be understood that the authoring system server 210 and the client authoring system 115 comprise at least a portion of a learning content management system, or LCMS.

In this embodiment, the content delivery database server 205 comprises a database server, such as a SQL server. However, any database system capable of storing and retrieving information, such as those commercially available from, for example, the Oracle Corporation or IBM, is within the scope of the present invention. The delivery engine 105 is capable of using the content delivery database server 205 for storing, accessing and retrieving a variety of information.

In one embodiment, the authoring system server 210 comprises a web server. Web servers, which are of widespread use in the technology, are capable of transmitting content over the Internet using one or several Internet language protocols, for example the Hypertext Mark Up Language (HTML) or the Extensible Mark Up Language (XML). A web server can be configured to accept requests from Internet web browsers and return the appropriate electronic documents pursuant to the request. A number of servers or client-side technologies can be used to increase the power of the web server beyond its ability to deliver standard electronic documents. For example, such technologies include Common Gateway Interface (CGI) scripts, Secure Sockets Layer (SSL) security, and Access Server Pages (ASP's).

In one embodiment, the authoring system server 210 includes an API used to accept content from external authoring systems. This external content may be XML tagged by the authoring system server 210 in accordance with a predefined data type definition (DTD). The authoring system server 210 tags the incoming content in such a way that the intended target computer is able to identify the purpose of the data. For example, the content may be tagged differently depending on whether the incoming content is an LO, a TI or CI's associated with an LO or a TI, etc. The authoring system server 210 is capable of transferring information between the authoring system 115 (or a plurality of authoring systems 115) and the content delivery database server 205. The authoring system 115 and the authoring system server 210 can use an API that defines XML definitions of data and automatic content procedures. Using the API, the authoring system 115 can create and modify courses on the delivery engine 105. The content delivery database server 205 can be configured to use an import content service to receive information from the authoring system server 210. The content delivery database server 205 is capable of receiving requests from the authoring system server 210 for storing, accessing and retrieving a variety of information.

As disclosed in the foregoing, FIG. 2 illustrates the authoring and management interface system 200. As shown in FIG. 2, the content delivery API system 215 transfers information between the learning management system 120 and the content delivery database server 205. The learning management system 120 and the content delivery API system 215 use an API that defines significant events detected by the system. The significant events include events such as a student's response to an assessment question, a request to activate an exam, a request for authorization, a request for a list of available exams, actions associated with the management of visual styles, and the like. In one embodiment, the content delivery API system 215 communicates with the content delivery database server 205 by Java DataBase Connectivity (JDBC). JDBC is a Java specification for connecting to SQL-based databases. In one embodiment, the content delivery API system 215 communicates with the content delivery database server 205 by web services.

As shown in FIG. 2, the content delivery system 220 exchanges information between content delivery database server 205 and the student's browser 110. In one embodiment of the invention, the content delivery system 220 is a web server, although in other embodiments the content delivery system 220 may be other types of computing devices. The student's browser 110 and the content delivery system 220 may communicate via Hypertext Transfer Protocol (HTTP), or by way of other data transfer methods. In another embodiment of the invention, the student's browser 110 and the content delivery system 220 communicate using a secured communications protocol, such as, for example, secured URL, Hypertext Transfer Protocol Secure (HTTPS), or the like, which may be directed by the learning management system 120.

As shown in the embodiment of FIG. 2, the delivery engine 105 includes the external content caching API system 225. The external content caching API system 225 may communicate with an external content origin server 230 to provide educational content, from sources external to the delivery engine 105, to the student's browser 110. The external content caching API system 225 may directly provide educational content to the student's browser 110. In one embodiment, the student's browser 110 and the external content origin server 230 advantageously use URL redirects from the original server to communicate. Therefore, the student's browser 110 may receive content directly from the delivery engine 105, or the student's browser 110 may receive content indirectly from the delivery engine 105 via the external content origin server 230.

The learning management system 120 also communicates with the student's browser 110. A student using the student's browser 110 may communicate with the learning management system 120 to gain access to the delivery engine 105. Once access is gained, the student's browser 110 may retrieve content, exams, and other services available through the delivery engine 105. The student's browser 110 and the learning management system 120 may communicate using a secured communications protocol, such as, for example, secured URL, Hypertext Transfer Protocol Secure (HTTPS), or the like. Once authorized, the student's browser is preferably pointed to a secured URL to access requested materials.

The content objects in the learning system 100 may be stored in a database structure in the content delivery database server 205. In this way, the content in the system is reusable. The content objects in the database may be reused for placement in another target indicator. Thus, any content or course developer can use the database and utilize the content objects.

The authoring system server 210 preferably includes a permissions module 213. In various embodiments, the permissions module 213 is configured to regulate users' access to content objects stored in the database server 205, in accordance with permissions that are specified for each object and/or user. The permissions module 213 can be responsible for obtaining permissions information for each object and/or user (e.g., by providing a dialog form for the input of permission information). The module 213 can also be configured to prevent users from accessing objects for which the users do not have the requisite permission. Further permissions aspects of the invention are described below. With reference to FIGS. 1 and 2, the permissions module 213 can alternatively be provided within the learning management system 120.

In one embodiment, there are actually two databases for storage of content: the content delivery database server 205 and a database within the authoring system server 210, both of which can store production copies of the LO's for use by students. The databases 205 and 210 preferably can store all successively made versions of the content and are preferably not directly accessible to students.

In preferred embodiments, the system is configured to provide users (e.g., students, authors, administrators) the capability to search content objects. In one embodiment, a user may search a repository of content objects (e.g., content items) in view of a particular keyword. This feature may enable a user to design a customized course. As an example, suppose a student has completed a “Learning Physics” course and desires to learn more about a particular physics principle, such as kinetic energy. The student may search the repository of content items with “kinetic energy” inputted into, e.g., a search field, and based on the search results, pick and choose certain content items to be included in the customized course. In another embodiment, the delivery engine 105 may be configured to automatically generate a course customized in view of a student's performance on particular assessment items. In an alternative embodiment, the student selects to have the delivery engine 105 build the customized course.

In one embodiment, content items may be delivered to a student in multiple formats, such as, e.g. PDF, Microsoft Word Document, Power point Presentation, etc. Additionally, a student may request that an entire course or a portion of a course be delivered to the student. In some embodiments, the system is configured to transmit the course material to the student via electronic mail (e-mail). In some embodiments, the system is configured to transmit the course material to a student's portable computer, such as, e.g., personal digital assistant (PDA).

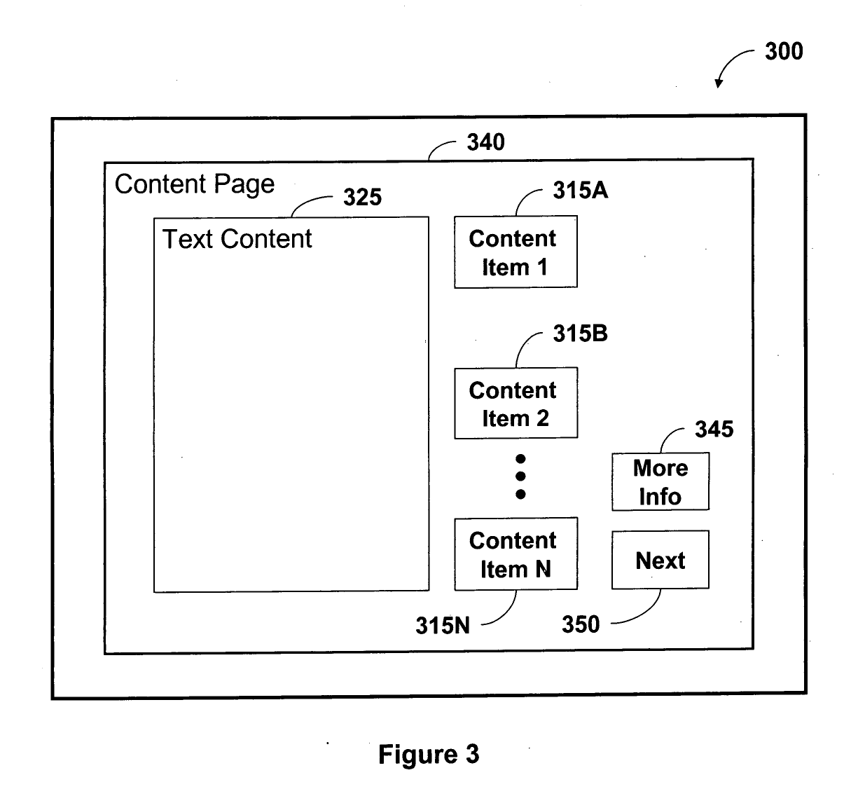

FIG. 3 illustrates a screen display of a lesson display screen 300, according to aspects of an embodiment of the invention. As shown in FIG. 3, the lesson display screen 300 includes the content page 340, which is a content item that displays information to be taught to a student. The content page 340 includes at least one text content item 325 and one or more other content items or content sections 315A-315N. The content items can include text, video or sound files that relate to the text content 325. In one embodiment, each of the content items or content sections 315A-315N and text content 325 relate to a single target indicator. For example, each would provide a different way to teach a student how to program the “PRINT” command in Visual Basic.

In addition, the content page 340 can include other controls, such as a “MORE INFO” button 345 or a “NEXT” button 350. Selecting the button 345 can bring up additional curriculum relating to the target indicator being taught. Moreover, content items 315A-315N with varying levels of difficulty can be provided so that the students can challenge themselves with more difficult topics. The system thereafter is capable of tracking the progress and determining the level of the student's knowledge by analyzing the content items they viewed, and their score on assessment items associated with the content items.

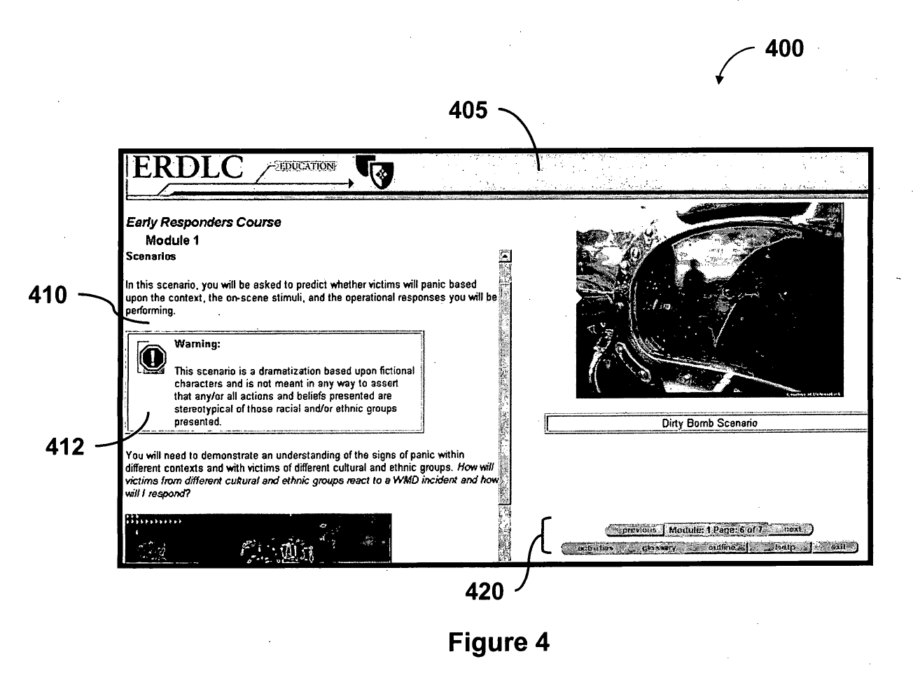

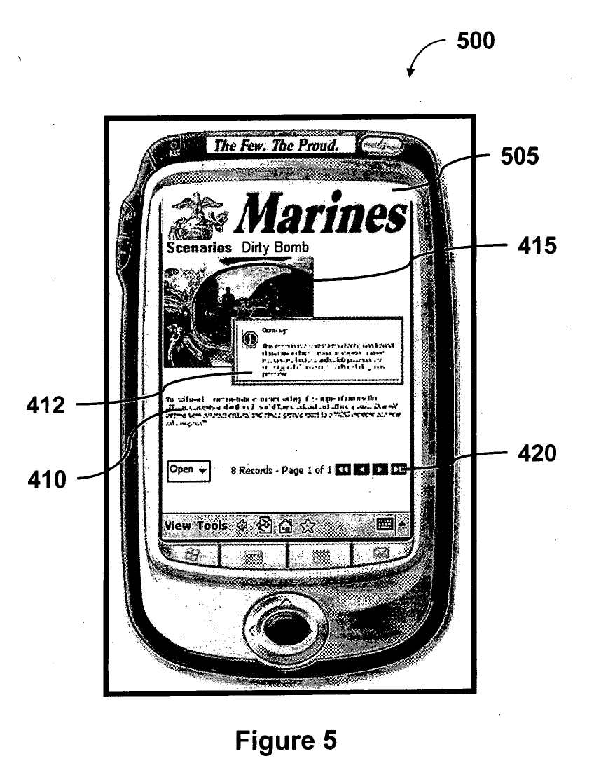

It should be realized that the content page 340 has a particular visual style (see below). Thus, all of the content delivered and rendered within the content page 340 will have the same style. Because the content items are not bound to any particular style, they can be rendered into a plurality of differing styles. For example, multiple different styles of the content page 340 could be used to display the same content items. This will be understood more completely with reference to FIGS. 4 and 5 below.

FIG. 4 is a screen capture 400 of a lesson page, wherein the lesson page is displayed within a content page 405. The content page 405 controls the look and feel of the content items that are displayed. As shown, the content page has a visual style adapted for display on a normal sized computer display screen. There is a text content item 410 on the left side that displays text relating to an “Early Responders Course”. Within the text is a warning 412 regarding the content. On the right side of the content page 405 is an image 415 of an emergency worker. The lower right corner has a series of control buttons 420 that allow the student user to control movement within the course, or ask for help.

FIG. 5 is a screen capture 500 of the same content, but the content is displayed within a different content page 505 that is configured to display the lesson on a personal digital assistant (PDA). As shown, the image 415 is displayed at the top of the PDA. The text content item 410 is displayed directly below the image 415. The warning 412 is no longer within the text of the text content item 410, but is now displayed in the center of the PDA screen, and appears as a pop-up message. The control buttons 420 appear with iconic labels as is typical of PDA controls.

While certain visual styles have been shown in the illustrated embodiments of FIGS. 4 and 5, it will be appreciated that a great variety of different types of visual styles (with different selections and arrangements of text and images) can be used.

Thus, the same content can be rendered in two different ways, in this case for a computer display and for a PDA, by choosing a different content page. Each content page has a particular visual style that controls the way that content is displayed to a student user. Because the content items can be shared and displayed in different curricula and within different content pages, one embodiment of the invention allows authors to set permissions which control how and if particular content can be shared with other authors.

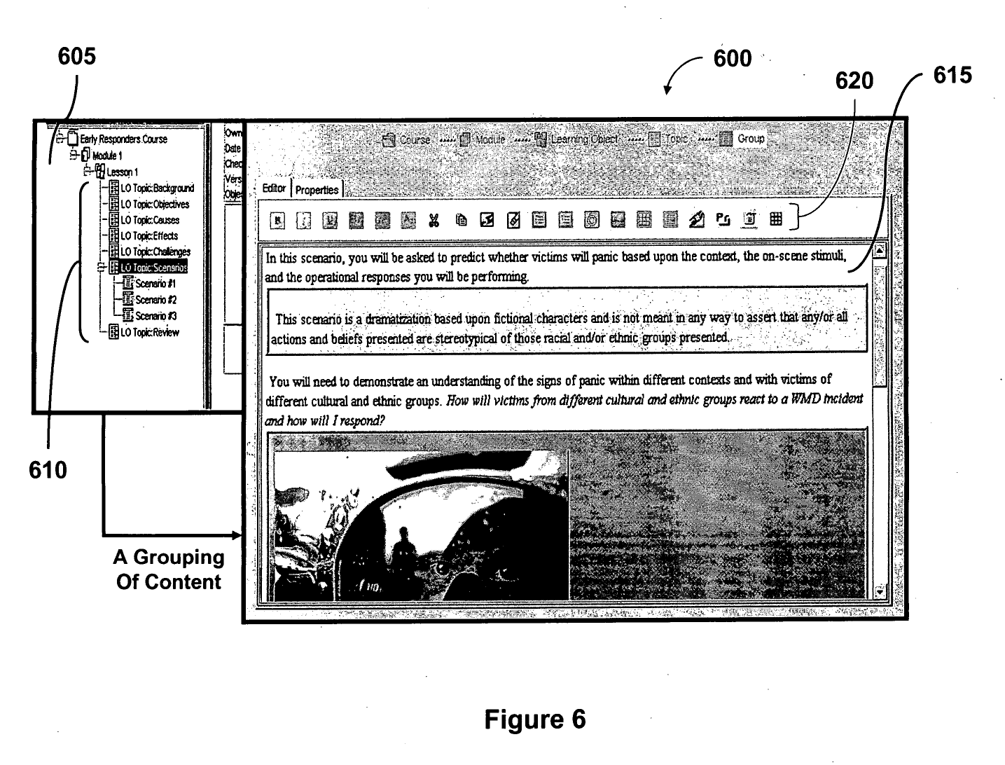

FIG. 6 is a screen capture 600 of the authoring system 115 (FIG. 2). As shown, the left portion of the interface contains an explorer window 605 that displays a tree 610 of the content items that are being developed by the author. The right portion of the interface contains an editor window 615 that displays the content that will appear before a student that accesses it. A toolbar 620 is provided to allow the author to edit the content items within the editor window 615. The displayed content items are preferably tagged with metadata that describes some of the content as not being generic to the grouping, but being associated with a “warning” or a “note” and so on. FIGS. 4 and 5 show different potential rendering experiences for the student of this material, based upon whatever branding/navigation/business rules/modality/learner preferences are appropriate for that student.

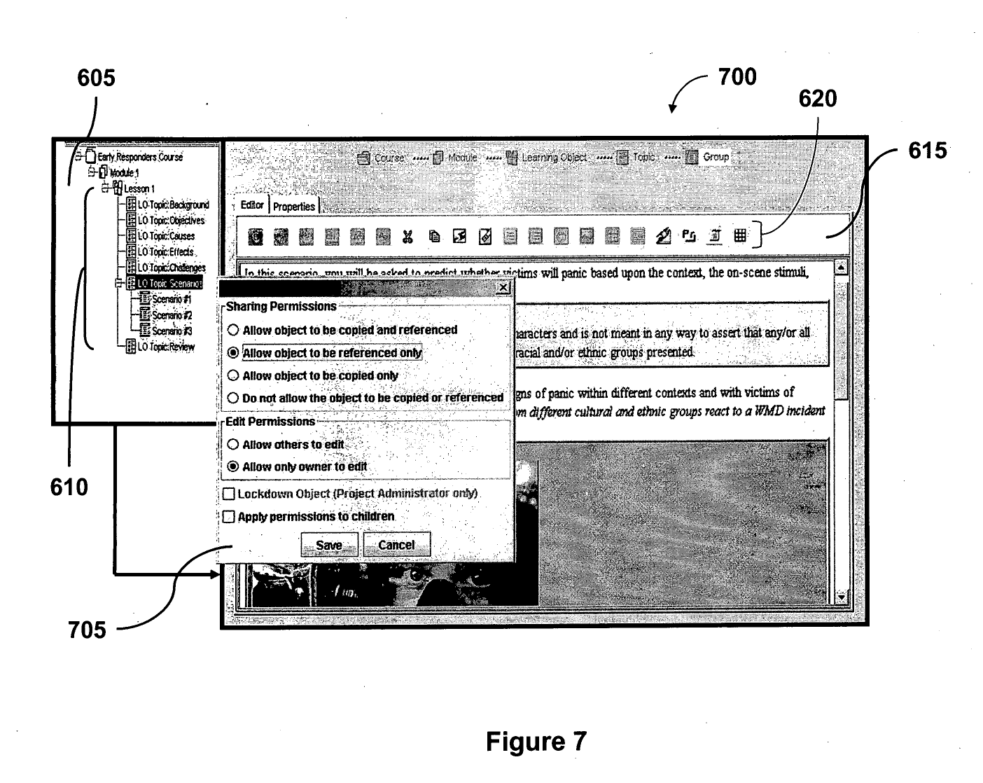

FIG. 7 is a screen capture 700 of the authoring system 115 once a permissions window 705 has been activated. In one embodiment, the permissions window 705 is activated when the author right clicks a mouse pointer on a content item within the tree 610. Of course, one of skill in the art could implement a variety of ways for causing the permissions window to be displayed to the author without departing from the spirit of the invention. As shown, the permissions window 705 contains a variety of permission options as listed below. In this context, allowing an object to be copied means allowing a “repurpose” of the object, which, as described above, means allowing other authors to insert an editable copy of the object into their own course materials. Allowing an object to be referenced means allowing other authors to insert a read-only copy of the object into their own course materials. Allowing an object to be edited means allowing other authors to modify the original object.

Allow object to be copied and referenced (preferred default setting)

Allow object to be referenced only

Allow object to be copied only

Do not allow object to be copied or referenced

Allow others to edit (preferred default setting)

Allow only owner to edit

Lockdown object

Apply the same permissions settings to child objects of the object

While for most of these options the owner and Project Administrator may be the only authors that can specify the sharing permissions, the system can be configured to allow only the Project Administrator to choose to “Lockdown” an object. When an object is locked down, it cannot be used and/or altered by any author. This allows the Project Administrator to freeze the work being done on any particular project if necessary. In one embodiment, the sharing permissions can only be set on an object if the user has the object “checked-out” of the server, i.e., downloaded the object for modifying it. In one embodiment, the permissions module 213 (FIG. 2) controls all of the permissions aspects of the system. In other embodiments, an optional permissions module 116 associated with the authoring system 115 works in tandem with the permissions module 213. For example, the permissions module 116 can be used to adjust and store permissions settings for materials that an author develops while offline (i.e., while not connected to the server 210), it being understood that the permissions settings will be stored and appropriately processed by the permissions module 213 when the author's client computer goes back online (i.e., reconnects to the server 210).

In one embodiment, the system provides a way to either set the permissions on just the content object or set the permissions on the content object and recursively on all the children content objects for which the user is the owner. It should be noted that permissions on objects that are merely referenced (e.g., a hyperlink to the object is provided) are preferably not changed. However, if a child content object is not owned by the author, then the permissions are typically not automatically changed by the system for that child content object. If the user has Project Administrator authority, then the system can preferably change the permissions on the content object and all child content objects regardless of the owner. When a new child content object is created, it should normally inherit the permissions set on its parent object.

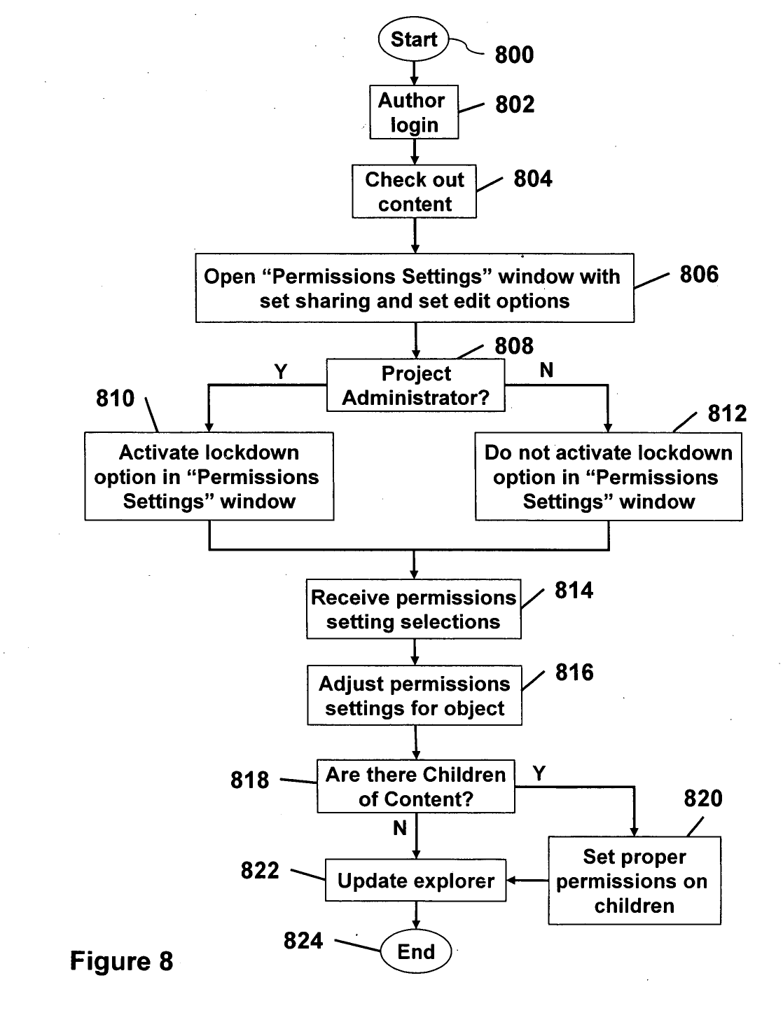

FIG. 8 is a flow chart illustrating a process of setting permissions on one or more content objects, in accordance with one embodiment. The process begins in a step 800. In a step 802, an author logs into the system. In a step 804, the author checks-out a content object (“content”, as illustrated) from the server. It will be understood that most or all of the following steps can be performed with the aid of the permissions module 213 and or the permissions module 116 (FIG. 2). In a step 806, the author opens a “Permissions Settings” window, which includes available options for setting sharing permissions and edit permissions. Next, in a step 808, it is determined whether the author is a project administrator. If the author is a project administrator, in a step 810 a lockdown option is activated in the “Permissions Settings” window (e.g., window 705 of FIG. 7). In this context, “activating” the lockdown option means making the option available. Otherwise, in a step 812 the lockdown option is not activated. The process then proceeds to a step 814, in which the system receives the author's sharing and edit permissions settings selections. In a step 816, the system adjusts the permissions setting for the object in accordance with the author's selections. In a decision step 818, it is determined whether the object includes any children objects (i.e., objects below the checked-out object in the content object hierarchy). If there are children objects, then permissions are set for them in a step 820 in accordance with desired permissions rules for children objects. After one or both of steps 818 and 820, the user interface of the author's client can be updated in a step 822, to reflect the adjusted permissions setting. The process then ends in step 824. Skilled artisans will appreciate that this process can be repeated for each checked-out object. It will also be appreciated that a variety of different methods of setting permissions are possible, including ones in which the settings for sharing, editing, and lockdown occur in different discrete steps.

With further reference to FIG. 8, there could be two additional steps between steps 820 and 822. After step 820, the user might check-in the content object. After that, the server preferably sends event messages to all other users enrolled in the same project space, the event messages informing the other users that permissions for this content object have been changed (if they have). The event message can also inform the other users that the content itself has been modified (if it has).

In some embodiments, in steps 806 and 808 the author may choose to set or not set edit permissions and sharing permissions. Additionally, the author may choose to set or not set permissions for the children content objects once edit and/or sharing permissions have been set for the parent content object. As an example, the author may set edit permissions for the content object and not set edit permissions for the children

Visual Styles

In some embodiments, users have the ability to add new visual styles to an existing theme or modify an existing visual style via a web page. In either case, the system preferably allows the deployment of new visual styles or modifications to existing visual styles without the need for a restart of the system in order for the changes to be effective.

As used herein, a “theme” relates to the presentation structure of content. For example, the theme might dictate that content items of the type “main media” must display on the top-right portion of the client's display. A theme might require that content items of the type “instructor note” cannot be displayed to students. A theme might dictate that content items of the type “warning” must pop up into a small modal window in front of the rest of the material (i.e., a “pop-up window”). A theme might dictate that a link to navigate forward to the next content object must appear in the lower-right corner of the client's display. Themes can include a multitude of other structural requirements. As used herein, a “visual style” relates to aspects such as branding, logos, images, fonts, colors, and the like. A “content style” describes the resultant effect of applying both the theme and visual style to a set of content objects.

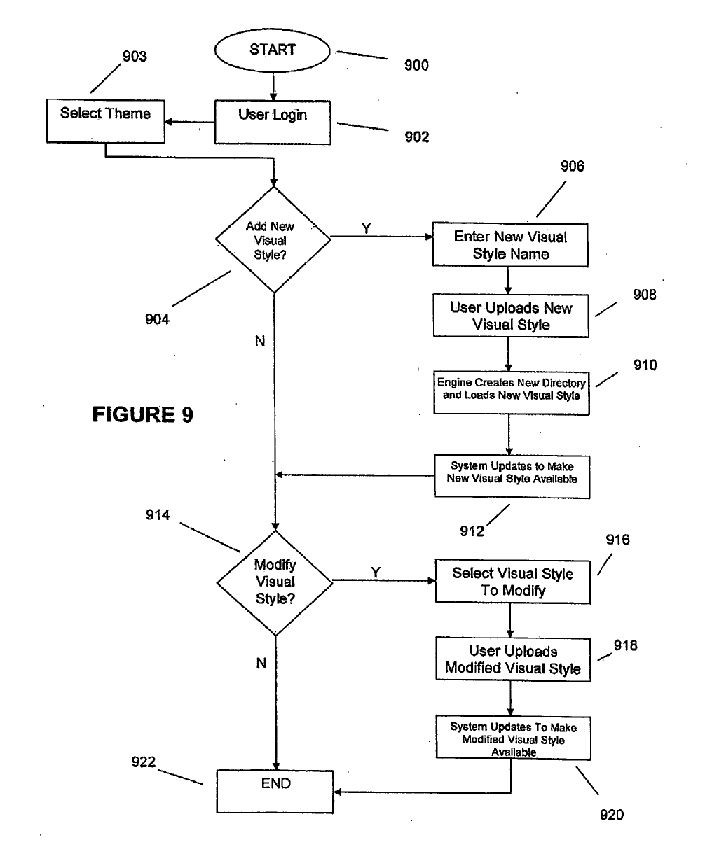

FIG. 9 is a flow chart illustrating a process by which a user adds or modifies a visual style (and/or theme, in some embodiments), in accordance with one embodiment. The process begins in a step 900. In a step 902, a user logs into the system. During the log-in step the system may determine whether the user has permission to modify a stored visual style or add a new visual style. If the user does not have permission to modify a stored visual style or add a new visual style, the user will not be allowed to do so. In a step 903, the user selects a theme. In a decision step 904, the system determines whether the user has selected to add a new visual style. If the user has not selected to add a new visual style, the process proceeds to a decision step 914. On the other hand, if the user has selected to add a new visual style, then the new visual style's name is received from the user in a step 906 and the user uploads the new visual style in a step 908. Each visual style can comprise a package of computer files that are zipped together as a single file for upload to the server, whereupon the server can unzip the visual style package. In a step 910, the server creates a new directory for the new visual style and loads the new visual style in the new directory. In a step 912, the system updates itself so that the new visual style is available to users without necessitating a system restart. The process then proceeds to the decision step 914, in which the system determines whether the user has selected to modify a visual style. If not, the process ends in a step 922. If the user has selected to modify a visual style, then the visual style to modify is selected in a step 916. In a step 918, the user modifies and uploads the selected visual style to the server. In a step 920, the system updates itself so that the modified visual style is available to users without necessitating a system restart. The process then ends in the step 922.

Each theme can include a number of default visual styles. In a preferred embodiment, users cannot modify or replace any of the default visual styles. The system can be configured to validate or confirm the workability of the newly-created and modified visual styles (e.g., by confirming that they conform to pre-selected standards).

The system can provide the ability for an organizational administrator to add new visual styles or modify existing visual styles for which the organizational administrator has permissions (e.g., granted by a super administrator). For example, the organizational administrator might only have permission to add or modify visual styles within certain themes. In one embodiment, a style workbook and/or a content style package can be associated with each organization. The style workbook and content style package preferably provide a selection of differing stylization options to assist the administrator in creating and/or modifying visual styles and/or themes. The process by which an organizational administrator would add or modify a visual style or theme is preferably similar to that shown in FIG. 9.

Typically, super administrators will also have the ability to add or modify visual styles for all available themes. Super administrators will typically also have the ability to designate for each organization which visual styles can be modified by the organization administrators. In one embodiment, neither super administrators nor organization administrators have the ability to modify default visual styles.

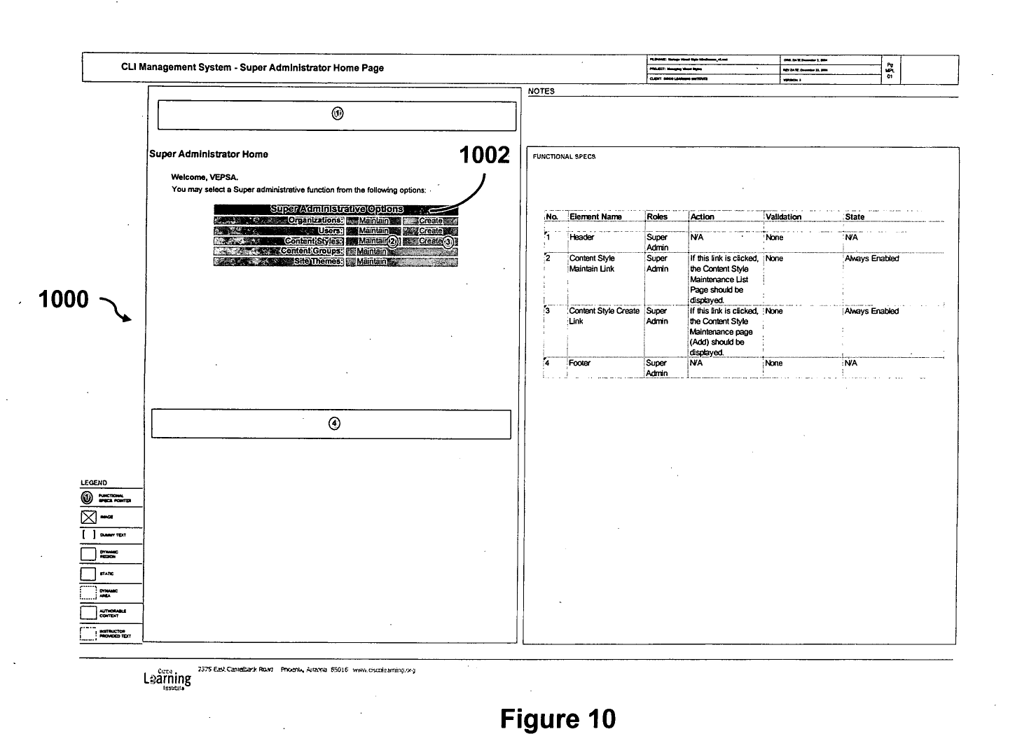

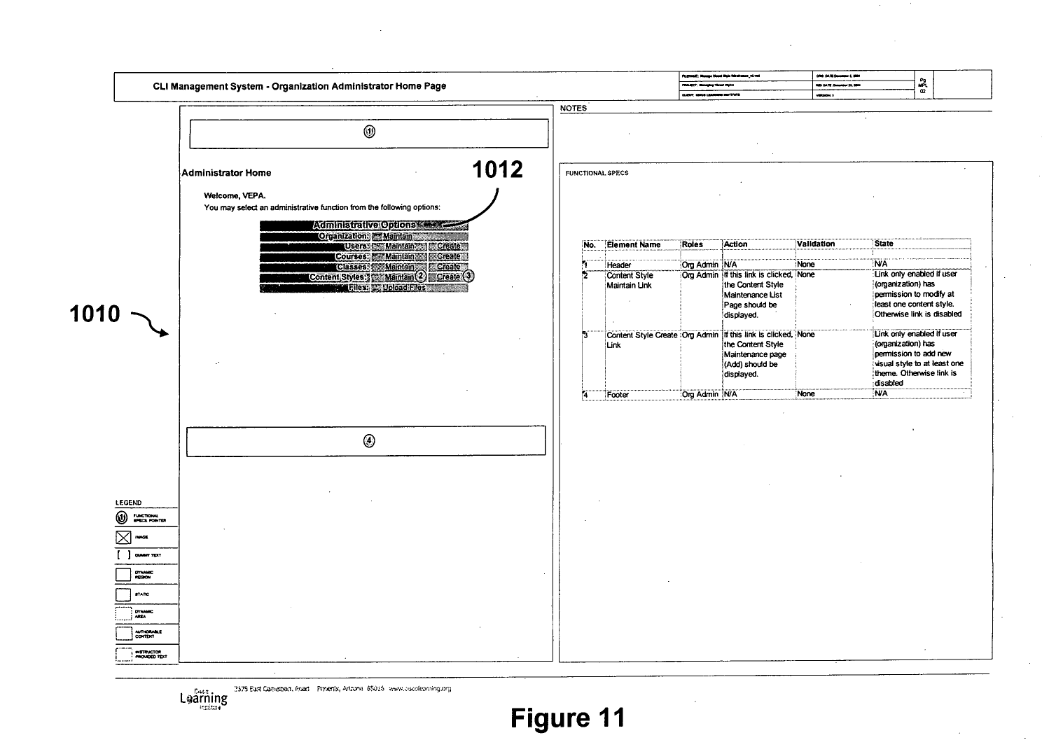

The left half of FIG. 10 is a screen capture of a super administrator home page 1000 (e.g., a web page or a screen produced by a dedicated software program) in accordance with one embodiment of the invention. The page 1000 is preferably obtained when a super administrator logs into the system. The page 1000 includes an options box 1002 that allows the super administrator to perform maintenance tasks and creation tasks. In particular, the options box 1002 preferably includes hyperlinks to different web pages for maintenance of organizations, creation of new organizations, maintenance of users, creation of new users, maintenance of content styles, creation of new content styles, maintenance of content groups, and/or maintenance of site themes. A “content group” is a grouping of content materials in the content delivery database server 205 (FIG. 2), for which access is limited to a defined group of instructors. FIG. 10 illustrates a content style maintenance link 2 (“Content Style Maintain Link”, as illustrated) and a content style creation link 3 (“Content Style Create Link”, as illustrated). In the illustrated embodiment, these links direct the user to a content style maintenance list page and a content style maintenance page, respectively. Skilled artisans will appreciate that the functionality of the illustrated super administrator home page 1000 can be provided in a variety of different ways and types of interfaces without departing from the spirit and scope of the invention. The same is true for the screen captures shown in FIGS. 11-16 and described below.

The left half of FIG. 11 is a screen capture of an organization administrator home page 1010 (e.g., a web page or a screen produced by a dedicated software program) in accordance with one embodiment of the invention. The page 1010 is preferably obtained when an organization administrator logs into the system. The page 1010 includes an options box 1012 that allows the organization administrator to perform maintenance tasks and creation tasks. In particular, the options box 1012 preferably includes hyperlinks to different web pages for maintenance of the administrator's organization, maintenance of users of the organization, creation of new users for the organization, maintenance of courses for the organization, creation of new courses for the organization, maintenance of classes for the organization, creation of new classes for the organization, maintenance of content styles associated with the organization, and/or creation of new content styles for the organization. In addition, the options box 1012 preferably includes a hyperlink for uploading files to the server, such as modified or new courses, classes, visual styles, and content styles. FIG. 11 also illustrates a content style maintenance link 2 and a content style creation link 3. In the illustrated embodiment, these links direct the user to a content style maintenance list page and a content style maintenance page, respectively, which can be different than those described with respect to FIG. 10 (e.g., tailored to the organization administrator).

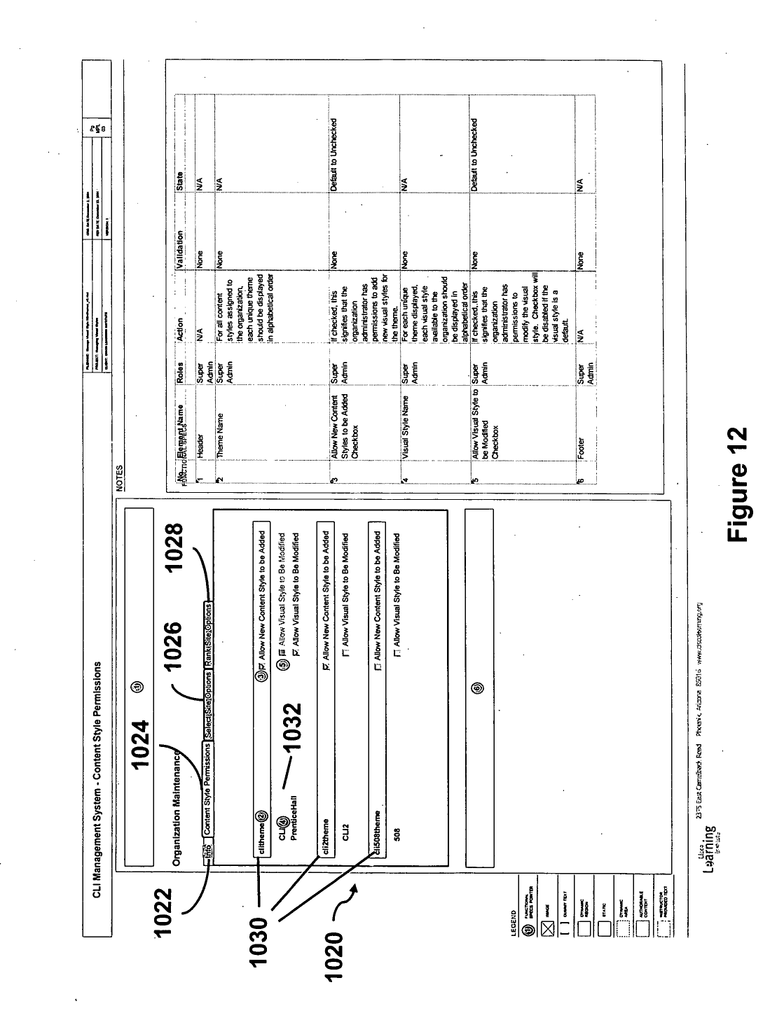

The left half of FIG. 12 is a screen capture of a content style permissions page 1020 (e.g., a web page or a screen produced by a dedicated software program) in accordance with one embodiment of the invention. The page 1020 is preferably provided to super administrators to set content style permissions for organization administrators. The page 1020 includes a content tab 1022 labeled “Info,” a tab 1024 labeled “Content Style Permissions,” a tab 1026 labeled “Select Site Options,” and a tab 1028 labeled “Rank Site Options.” The content associated with the Content Style Permissions tab 1024 is displayed. There are three theme headings 1030 shown, each of which identifies a theme by its name and includes a checkbox for selecting whether the organization administrator can add new content styles to the theme. Listed underneath each theme heading 1030 are visual style names 1032 and associated checkboxes for selecting whether the organization administrator can modify the theme.

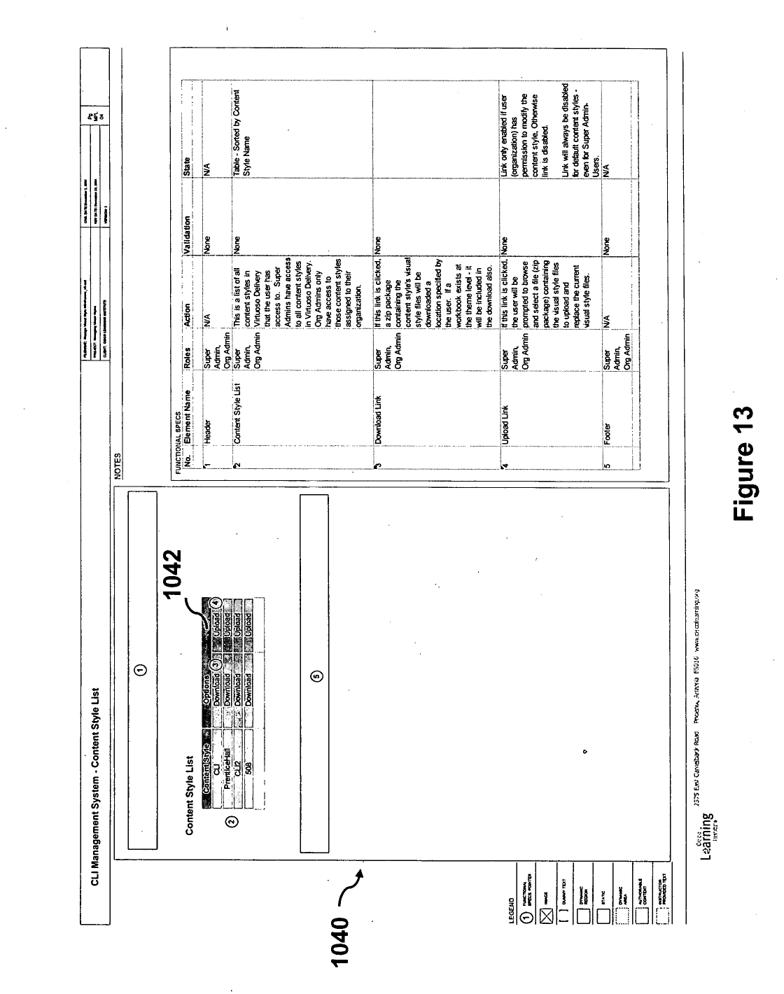

The left half of FIG. 13 is a screen capture of a content style list page 1040 (e.g., a web page or a screen produced by a dedicated software program) in accordance with one embodiment of the invention. The page 1040 can be provided to super administrators, organization administrators, or other users. The page 1040 includes a content style list box 1042, which includes a list of all of the content styles to which the user has access, wherein access is determined based on the user's permissions as described above. For each listed content style, the list box 1042 includes a download link and an upload link. Selection of a download link causes the server to send the content style to the user's client, and selection of an upload link causes the client to send the content style (e.g., a modified content style) to the server.

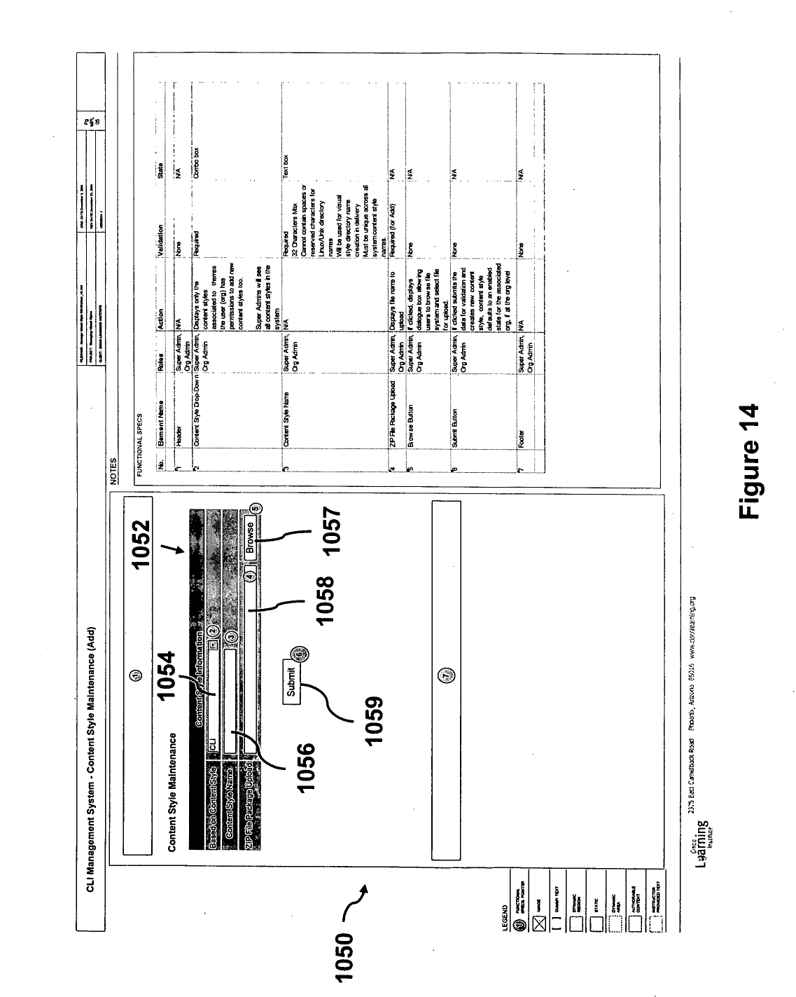

The left half of FIG. 14 is a screen capture of a content style maintenance page 1050 (e.g., a web page or a screen produced by a dedicated software program) for adding a new content style, in accordance with one embodiment of the invention. The page 1050 includes a content style information box 1052. The information box 1052 includes a drop down menu 1054 from which the user can select an existing content style that the new content style is based upon. In other words, the new content style is a modification of the selected existing visual style. The information box 1052 also includes a content style name field 1056 for entering the name of the new content style, and a new content style file package location field 1058 for entering the path of the new content style stored on the client's local storage (e.g., hard drive). In the illustrated embodiment, the new content style includes a plurality of computer files that are compressed together into one zip file. A browse button 1057 can also be provided for selecting the content style file by a computer mouse in a windows-based system. A submit button 1059 is provided to initiate the upload. The system can be configured to validate the uploaded file (e.g., a zip file and its contents) to ensure that it meets required format requirements. The content style maintenance page 1050 can preferably be used only by users who have permission to add new content styles.

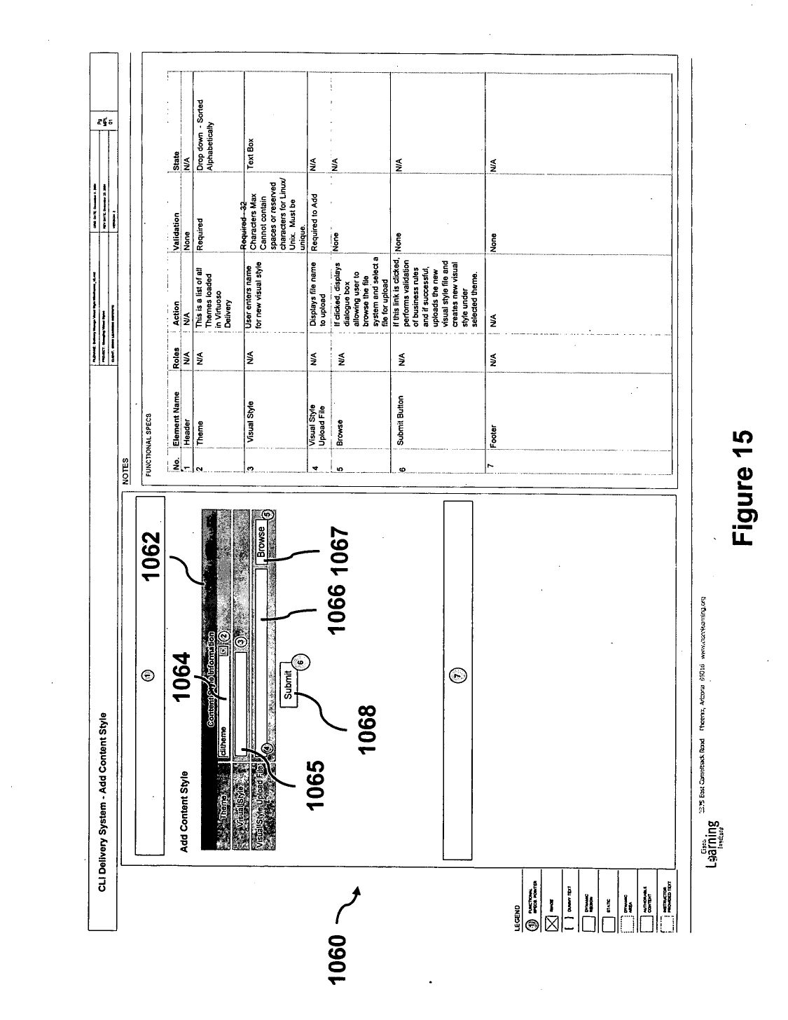

The left half of FIG. 15 is a screen capture of a content style addition page 1060 (e.g., a web page or a screen produced by a dedicated software program) for adding a new content style, in accordance with one embodiment of the invention. The page 1060 differs in functionality from the page 1050 (FIG. 14) in that the former is designed for use when the new content style is based upon an existing content style, whereas the latter is designed for use when the new content style is completely new. The page 1060 includes a content style information box 1062, which in turn includes a theme selection drop down menu 1064, a new visual style name field 1065, a new visual style file location field 1066, a browse button 1067, and a submit button 1068 substantially as described above with reference to FIG. 14. The content style addition page 1060 can preferably be used only by users who have permission to add new content styles.

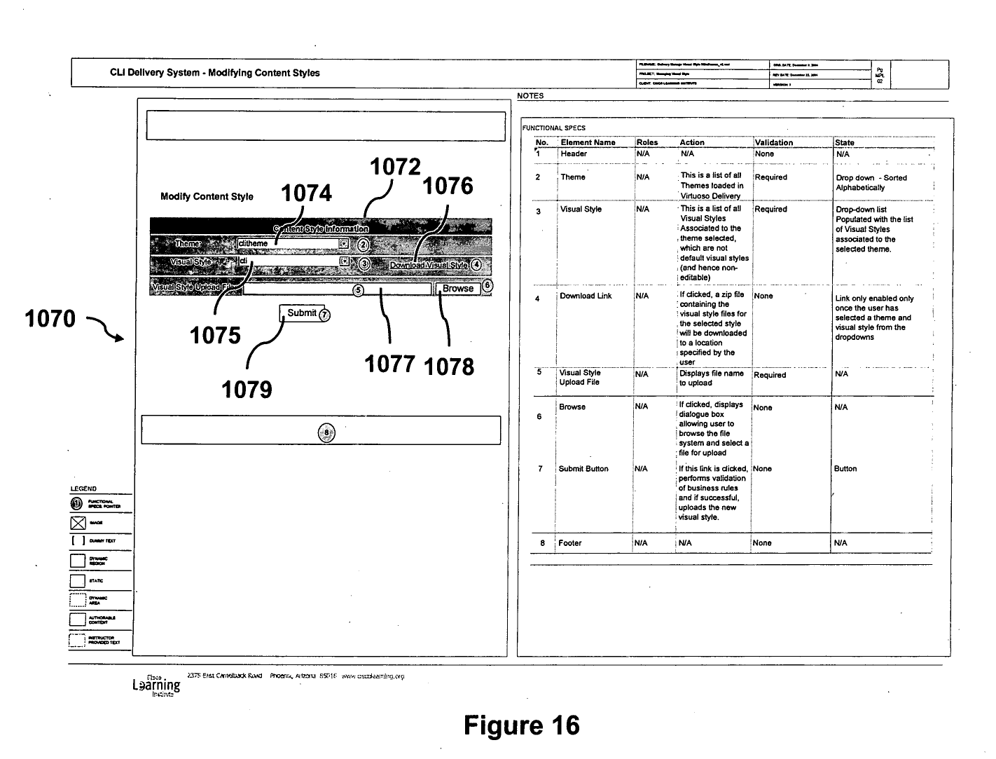

The left half of FIG. 16 is a screen capture of a content style modification page 1070 (e.g., a web page or a screen produced by a dedicated software program) for modifying a content style, in accordance with one embodiment of the invention. The page 1070 includes a content style information box 1072, which in turn includes a theme selection drop down menu 1074, a visual style selection drop down menu 1075, a hyperlink 1076 for downloading the selected visual style, a modified visual style file location field 1077, a browse button 1078, and a submit button 1079. The content style modification page 1070 can preferably be used only by users who have permission to modify existing content styles.

The system can also allow organization administrators to enable or disable content styles to control their availability to instructors of online learning programs. By default, all newly added content styles are preferably enabled. If a super administrator adds a new content style, by default it is preferably not assigned to any organization. If a super administrator assigns a content style to an organization, by default the organization preferably does not have permission to add new content styles to the theme or modify the existing visual style. If an organization administrator adds a new content style, the system preferably automatically assigns the content style (theme/visual style) to the administrator's organization. Preferably by default, the added content style is available for selection by instructors within the organization, and the organization administrator has permission to modify the content style. Themes may also have visual style workbooks, and the system can be configured to send the workbook as an accompaniment to each downloaded visual style. The system can be configured to prevent renaming of newly-created visual styles. In one embodiment, there is no functionality for deleting or deactivating a content style, since super administrators preferably have the ability to disassociate a content style from an organization and thereby remove it from end users' view. When a content style is disassociated from an organization, the system preferably provides an error message indicating the names of any classes currently using the content style, if any.

Shared Project Spaces

In a preferred embodiment, users are provided with the capability of sharing content objects between a plurality of project spaces, either within the same organization or different organizations. In one embodiment, a first organization can enable sharing of content objects between project spaces within an allocation controlled by the first organization, while a second organization is not permitted to access content objects of the first organization. In another embodiment, a first organization can share one or more content objects with a second organization. The second organization can dynamically render the first organization's content objects with the second organization's content style(s) to produce a course (or portion of a course) tailored to the second organization's theme(s) and visual style(s).

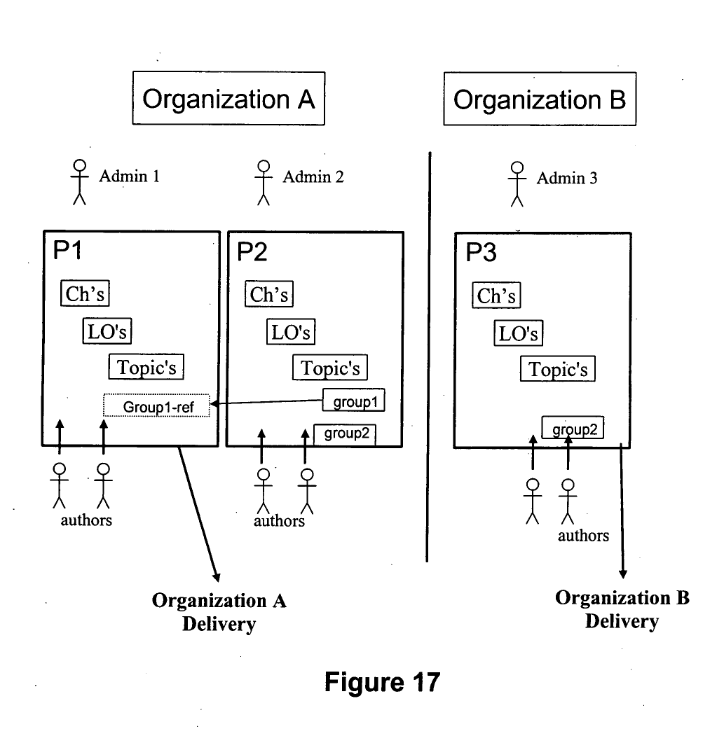

With reference to FIG. 17, a pristine sharing environment is illustrated in which users in a first organization share one or more content objects between different project spaces, but users in a second organization are not permitted to access content objects in the first organization. In the illustrated embodiment, the first organization (“Organization A”) controls projects spaces P1 and P2, and the second organization (“Organization B”) controls project space P3, with each project space P1, P2, and P3 comprising one or more content objects. As noted, users in Organization A are unable to access project spaces in Organization B, and vice versa. A project space in each organization preferably includes one or more content object hierarchies.

With continued reference to FIG. 17, project space P1 is managed by an administrator “Admin 1,” project space P2 is managed by an administrator “Admin 2,” and project space P3 is managed by an administrator “Admin 3.” Additionally, each organization is managed by an organizational administrator (not shown). Admins 1, 2 and 3 set sharing and edit permissions within their respective project spaces, which dictate whether an author (or groups of authors) has permission to, e.g., obtain an editable copy of a content object (a “repurpose”), link to a content object, or reference one or more content objects from an external project space. For example, as illustrated in FIG. 17, Admin 2 may give authors working in P1 permission to reference a content object in P2. Preferably, each organizational administrator can also control the project space(s) that any given author can access. For example, the organizational administrator for Organization A can give one or more authors working in P1 permisssion to reference a content object in P2.

In one embodiment, sharing of content objects between organizations enables use and reuse of content objects, thereby facilitating a customizable learning experience. As an example, suppose Organization A is a first university and Organization B is a second university. Dynamic rendering would enable a course (or a portion of a course) developed by the first university to be used by the second university with the second university's content style, thereby creating a course customized to the second university's themes and visual styles. As an example, a content item developed by the first university may be dynamically rendered with the second university's content style to display the second university's colors and mascot, in addition to the arrangement of subservient content items and content sections desired by the second university.

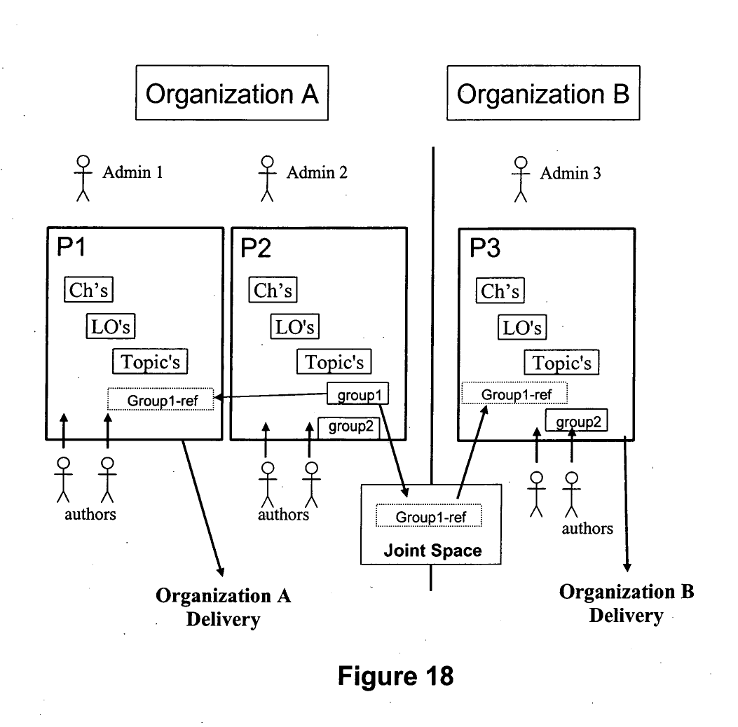

With reference to FIG. 18, in one embodiment of the invention, a pristine sharing environment is illustrated in which users in Organization B are granted access to one or more content objects in Organization A via a “trust relationship” established between the two organizations. In the illustrated embodiment, users in P3 have requested access to a particular content object “group 1” in P2. The organizational administrator of Organization A creates a project space (“Joint Space”) that is accessible to the organizational administrator of Organization B. In this example, the Joint Space is owned by Organization A. Both organizational administrators have access to the Joint Space, can manipulate content therein, and can provide like privileges to their project administrators (e.g., Admins 1, 2, and 3) and authors. In the present example, Admins 2 and 3 and the two organizational administrators can grant select authors (or groups of authors) permission to access the Joint Space, enabling those authors to, for example, repurpose, reference, and/or link to content objects within the Joint Space. In one embodiment, authors from Organizations A and B can work cooperatively to build a project within the Joint Space, the project comprising one or more courses and content objects. The project could subsequently be transferred to each organization's project space and, upon association with each organization's content style, generate a course tailored to each organization.

With continued reference to FIG. 18, an author associated with P2 sets the content object group1 as reference only and “sponsors” a reference to group 1 into the Joint Space. An author associated with P3 can insert a reference to group 1 into the author's course materials in P3. When Organization B publishes a course, the course is properly rendered with Organization B's content style.

Thus, a method is provided by which content developed by one organization can be used by another organization to generate (or publish) course material tailored to the other organization's themes and visual styles.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

It will be appreciated by those skilled in the art that various other omissions, additions and modifications may be made to the methods and systems described above without departing from the scope of the invention. All such modifications and changes are intended to fall within the scope of the invention, as defined by the appended claims.

We claim:

1. A system for managing content for a distributed learning system over an electronic network, comprising:
one or more servers storing a plurality of educational courses configured to be delivered electronically to students over the network, at least some of the courses comprising one or more content objects also stored on the one or more servers, at least some of the content objects being reusable content objects configured to be used in more than one of the courses; and
a permissions module configured to regulate whether users can use the reusable content objects in the courses, based upon permission settings stored in association with the reusable content objects.

2. The system of claim 1, wherein the content objects are organized in accordance with a content object hierarchy and at least one of the content objects is stored in association with formatting data specifying the content object's location within the content object hierarchy.

3. The system of claim 2, wherein the formatting data specifies an instructional strategy that dictates how the content object should be presented to a student on a client computer screen.

4. The system of claim 2, wherein the formatting data comprises metadata.

5. The system of claim 1, wherein the permission settings comprise permissions indications for each of the reusable content objects.

6. The system of claim 1, wherein the permissions module regulates access to said reusable content objects based upon the status of users requesting said access.

7. The system of claim 1, wherein the permissions module is configured to provide a set of access levels to a reusable content object, the set of access levels comprising one or more of: (1) providing no access to the reusable content object, (2) only allowing the reusable content object to be viewed, (3) allowing use of a read-only copy of the reusable content object, (4) allowing use of an editable copy of the reusable content object, and (5) allowing the reusable content object to be modified.

8. The system of claim 1, wherein the permissions module is configured to receive the permission settings from users over the network, and to store the permission settings.

9. The system of claim 1, further comprising an authoring system configured to allow users to create the courses and/or content objects.

10. The system of claim 1, further comprising a learning content management system configured to store successive versions of the content objects.

11. A method of regulating access to educational content objects over an electronic network, for a distributed learning system, comprising:
storing a plurality of educational courses configured to be delivered electronically to students over the network, at least some of the courses comprising one or more content objects, at least some of the content objects being reusable content objects configured to be used in more than one of the courses;
receiving a user's request to add one of the reusable content objects to one of the courses;
retrieving permissions information associated with the requested content object; and
providing or not providing access to the requested content object, in accordance with the permissions information.

12. The method of claim 11, wherein the content objects are organized in accordance with a content object hierarchy, at least one of the content objects being stored in association with formatting data specifying the content object's location within the content object hierarchy.

13. The method of claim 11, wherein providing or not providing access comprises providing access.

14. The method of claim 13, wherein providing access comprises allowing the user to insert an editable copy of the requested content object into said one of the courses.

15. The method of claim 13, wherein providing access comprises allowing the user to insert a read-only copy of the requested content object into said one of the courses.

16. The method of claim 13, wherein providing access comprises allowing the user to edit the requested content object.

17. A method of regulating permission settings of one or more content objects associated with a distributed learning system, the content objects being stored in association with a plurality of educational courses configured to be delivered electronically to students, the permission settings governing users' abilities to add selected ones of the content objects to the courses, the method comprising:
receiving a request from a user to modify permission settings for an identified one of the content objects;
retrieving access information associated with the user; and
allowing or not allowing the user to modify the permission settings for the identified content object and any content object below the identified content object in a hierarchical course outline of one of the courses, based on the access information.

18. The method of claim 17, wherein the content objects of the learning system are organized in accordance with a content object hierarchy, at least one of the content objects being stored in association with formatting data specifying the content object's location within the content object hierarchy.

19. The method of claim 18, wherein the formatting data also specifies an instructional strategy that dictates how the content object should be presented to a student on a client computer screen.

20. The method of claim 17, wherein the access information specifies that the user is an owner of the identified content object, and wherein allowing or not allowing comprises allowing.

21. The method of claim 17, wherein the access information specifies that the user is an administrator of an organization controlling the identified content object, and wherein allowing or not allowing comprises allowing.

22. The method of claim 17, wherein the access information specifies that the user is an administrator of the distributed learning system, and wherein allowing or not allowing comprises allowing.

23. The method of claim 17, wherein allowing or not allowing comprises allowing, the method further comprising informing other users that the permission settings for the identified content object have been modified.

24. A system for controlling content styles for the presentation of educational courses over an electronic network, comprising:
one or more servers configured to store content styles, each content style configured to be selectively applied to one of more of the courses, each content style configured to control presentational formatting of an associated course delivered to students over the network; and
a content style module configured to regulate a user's ability to apply a selected one of the content styles to a selected one of the courses based upon stored access information of the user.

25. The system of claim 24, wherein at least some of the courses comprise content objects organized in accordance with a content object hierarchy, at least one of the content objects being stored in association with formatting data specifying the content object's location within the content object hierarchy.

26. The system of claim 25, wherein the formatting data also specifies an instructional strategy that dictates how the content object should be presented to a student on a client computer screen.

27. The system of claim 24, wherein at least some of the content styles are associated with individual organizations, and wherein the access information specifies whether the user is an author or administrator of an organization associated with the selected content style.

28. The system of claim 24, wherein at least some of the courses are associated with individual organizations, and wherein the access information specifies whether the user is an author or administrator of an organization associated with the selected course.

29. The system of claim 24, wherein the content style module is also configured to regulate the user's ability to apply the selected content style to the selected course based upon permission settings associated with the selected content style.

30. The system of claim 24, wherein the content style module is also configured to regulate the user's ability to modify the selected content style, based upon the stored access information of the user.

31. The system of claim 24, wherein the content style module is also configured to regulate users' abilities to add new content styles to the one or more servers.

32. A method of controlling content styles for the presentation of educational courses over an electronic network, comprising:
storing content styles configured to be selectively applied to one or more of the courses, each content style configured to control presentational formatting of an associated course delivered to students over the network;
receiving a request from a user's client computer to apply a selected one of the content styles to a selected one of the courses;
retrieving access information associated with the user; and
allowing or not allowing the user to apply the selected content style to the selected course, based upon the retrieved access information.

33. The method of claim 32, wherein allowing or not allowing comprises determining whether the access information specifies that the user is an author or administrator of an organization associated with the selected content style.

34. The method of claim 32, allowing or not allowing comprises determining whether the access information specifies that the user is an author or administrator of an organization associated with the selected course.

35. The method of claim 32, wherein allowing or not allowing comprises:
retrieving permission settings associated with the selected content style; and
allowing or not allowing the user to apply the selected content style to the selected course, based upon the retrieved permission settings and the retrieved access information.

36. The method of claim 32, further comprising allowing or not allowing the user to modify the selected content style, based upon the retrieved access information.

37. The method of claim 36, wherein allowing or not allowing the user to modify the selected content style comprises allowing the user to modify the selected content style, the method further comprising receiving a modified version of the selected content style from the user's client computer.

38. A method of controlling content styles for the presentation of educational courses over an electronic network, comprising:
storing content styles configured to be selectively applied to one or more of the courses, each content style configured to control presentational formatting of an associated course delivered to students over the network;
organizing the content styles within content theme directories;
receiving a request from a user to store a new content style within a selected one of the content theme directories;
retrieving permissions information associated with the content theme directory; and
permitting or not permitting the user to store the new content style within the selected content theme directory, based upon the retrieved permissions information.

39. The method of claim 38, wherein permitting or not permitting comprises:
determining from the permissions information that the user has permission to store the new content style within the selected content theme directory;
receiving the new content style from the user; and
storing the new content style within the selected content theme directory.

40. The method of claim 39, wherein receiving the new content style from the user comprises receiving a computer file.

41. The method of claim 39, wherein storing comprises creating a new sub-directory in the selected content theme directory for the new content style and loading the new content style in the new sub-directory.

42. A method of sharing content objects between project spaces, comprising:
providing a first project space associated with a first organization, the first project space including educational course materials configured to be delivered electronically to students over a network;
providing access to the first project space to a first plurality of authors associated with the first organization;
providing a second project space associated with a second organization, the second project space including educational course materials configured to be delivered electronically to students over the network;
providing access to the second project space to a second plurality of authors associated with the second organization;
preventing the first plurality of authors from accessing the second project space;
preventing the second plurality of authors from accessing the first project space;
providing a joint space accessible by the first and second pluralities of authors;
and
permitting at least some of the first plurality of authors to transfer content objects from the first project space into the joint space.

43. The method of claim 42, further comprising permitting at least some of the second plurality of authors to transfer content objects from the second project space into the joint space.

44. The method of claim 42, wherein the educational course materials of the first and second project spaces each comprise a plurality of content objects organized in accordance with a content object hierarchy, at least some of the content objects being stored in association with formatting data specifying the content objects' locations within the content object hierarchy.
